(19) United States
(12) Patent Application Publication
(10) Pub. No.: US 2002/0060595 A1
(43) Pub. Date: May 23, 2002

(54) Semiconductor integrated circuit and clock distribution method thereof

(75) Inventor: Toshihiko Nakano, Tokyo (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: NEC CORPORATION

(21) Appl. No.: 09/987,806

(22) Filed: Nov. 16, 2001

(30) Foreign Application Priority Data
Nov. 20, 2000 (JP) 353393/2000

(51) Int. Cl. G06F 1/04

(52) U.S. Cl. 327/295

(57) ABSTRACT

A semiconductor integrated circuit of the present invention includes: a plurality of areas which operate with independent clocks, respectively; and a phase separation element which differentiates the phase of one of the clocks from the phases of the other clocks and distributes the clocks to the areas, respectively. A clock distribution method of a semiconductor integrated circuit of the present invention includes: differentiating the phase of one of clocks from the phases of the other clocks; and distributing the clocks to areas, respectively, provided in a semiconductor chip and operating with independent clocks. A manufacturing method of a semiconductor integrated circuit of the present invention includes: forming a plurality of areas that operate with independent clocks to a semiconductor chip; and forming a phase separation element which distributes the clocks to the plurality of areas, respectively, with shifting phases by a length corresponding to a phase set for each of the areas.

### BACKGROUND OF THE INVENTION

(i) Field of the Invention

The present invention relates to semiconductor integrated circuits, particularly to semiconductor integrated circuits in which clock distribution is effectively controlled, and clock distribution methods thereof.

(ii) Description of the Related Art

In large-scale integrated circuits (LSIs), a tendency is to increase the chip size and the clock frequency year by year. This tendency is not weakened.

In conventional semiconductor circuits, generally 5 to 10% of the clock frequency is required for clock skew including process unevenness, clock distribution, and so on. However, since clock skew due to clock distribution increases as the semiconductor circuit area increases, the above number becomes hard to realize in recent years. This is because an increase in semiconductor circuit area results in many causes that increase clock skew, for example, the number of clock driver stages increases and the wiring between clock drivers becomes long.

For this reason, recently, how to decrease clock skew becomes more important than ever in LSI design. Nevertheless, many of techniques for decreasing clock skew cause an increase in power consumption of LSI. Therefore, it is also required to fully pay attention to power consumption and so on. This makes LSI design more difficult.

As described above, in conventional semiconductor integrated circuits, there are problems as described below.

First, the conventional semiconductor integrated circuits creates many causes that increase clock skew, which are difficult to hold down. Further, if the conventional techniques are used to decrease clock skew, power consumption of the LSI increases and LSI design becomes difficult.

In particular, at rising and falling of a clock, since many circuit elements operate at a time and thus currents flow simultaneously, a peak current in the circuit becomes high and big noise rides on the power supply line or the ground line. This may deteriorate circuit performance or cause the circuit an erroneous operation.

As a prior art against this problem, for example, there is a clock distributor disclosed in Japanese Patent Application Laid-open No. 08-008701, as shown in FIG. 10. In the prior art of FIG. 10, by inserting delay elements DLC1 to DLCn-1 in clocks between blocks to have delays, simultaneous operations of the blocks are avoided. The clock distributor is proposed in which peaks of operation currents are thereby dispersed, a momentary power supply voltage drop is made small, and stabilization of the circuit operation is intended. Incidentally, this method may be called delayed clock.

In this prior art, however, since the delay elements are provided in the clock lines, timing design of setup/hold in data input of the blocks 1 to n becomes complicated. Even on the data side, design must be performed so that setup/hold does not infringes by a method such as provision of delay elements DLI11 to DLI1n-1 and DLI22 to DLI2n-1, besides, even on the output side, it is required to ensure setup/hold in the subsequent synchronous circuit by a method such as provision of a delay circuit DLO22, so timing design becomes complicated. Further, to perform this process at every portion to which this method is applied, there is a disadvantage that the design cost increases considerably. Besides, since delay elements are inserted, there is a disadvantage that the circuit scale increases.

Second, in conventional semiconductor integrated circuits, there is a problem that memory macro such as RAM can not intend to perform an increase in speed corresponding to the increase in speed of clock.

An increase in speed of LSI is made possible by a minuteness in semiconductor process, but the minuteness of wiring is difficult in comparison with the minuteness of element and a delay due to wiring capacity becomes a hindrance to the decrease in speed. In memory macro such as RAM, such a delay due to wiring is great and an increase in speed corresponding to clock up trend can not be realized.

Besides, in case that the clock frequency exceeds 1 GHz, there may be a case that memory access time delays one cycle of the clock (hereinafter, this length of time will be referred to as “1T”). In this case, a path through the memory requires at least “2T” and the latency (delay time) becomes bad.

### SUMMARY OF THE INVENTION

An object of the present invention is to provide semiconductor integrated circuits and clock distribution methods thereof, in which a large number of steps are not required in clock distribution design, a decrease in clock skew of LSI is realized even in case of a large dye size, simultaneously, a peak current of LSI due to a clock distribution circuit can be held down, and the latency of a path through memory macro is never decreased more than necessity.

According to one aspect of the present invention, a semiconductor integrated circuit is provided which includes: a plurality of areas which operate with independent clocks, respectively; and a phase separation element which differentiates the phase of one of the clocks from the phases of the other clocks and distributes the clocks to the areas, respectively.

According to another aspect of the present invention, a clock distribution method of a semiconductor integrated circuit is provided which includes: differentiating the phase of one of clocks from the phases of the other clocks; and distributing the clocks to areas, respectively, provided in a semiconductor chip and operating with independent clocks.

According to another aspect of the present invention, a manufacturing method of a semiconductor integrated circuit is provided which includes: forming a plurality of areas that operate with independent clocks to a semiconductor chip; and forming a phase separation element which distributes the clocks to the plurality of areas, respectively, with shifting phases by a length corresponding to a phase set for each of the areas.

### BRIEF DESCRIPTION OF THE DRAWINGS

Other features and advantages of the invention will be made more apparent by the following detailed description and the accompanying drawings, wherein:

FIG. 1 is a diagram showing an example of semiconductor integrated circuit according to the first embodiment of the present invention;

FIG. 2 is a timing chart showing an example of clock distributed to areas in the semiconductor integrated circuit according to the first embodiment of the present invention;

FIG. 3 is a view showing an example of construction of the semiconductor integrated circuit according to the first embodiment of the present invention, which is divided into four areas bounded by the chip center;

FIG. 4 is a timing chart showing phases of clocks that a phase distribution section of the first embodiment of the present invention distributes to the areas of the semiconductor chip of FIG. 3;

FIG. 5 is a diagram showing an example of circuit construction of a phase separation element of the first embodiment of the present invention that distributes clock to the areas of the semiconductor chip of the embodiment of FIG. 3;

FIG. 6 is a diagram showing an inverter circuit as a clock driver;

FIG. 7 is a diagram showing an equivalent circuit of FIG. 6;

FIG. 8 is a view showing an example of semiconductor integrated circuit according to the second embodiment of the present invention;

FIG. 9 is a timing chart showing an example of clock of a core section and an IO section according to the second embodiment of the present invention; and

FIG. 10 is a diagram showing the construction of a conventional semiconductor integrated circuit.

In the drawings, the reference numerals represent the same structural elements.

### DETAILED DESCRIPTION OF THE PREFERRED EMBODIMENTS

The first embodiment of the present invention will be described below in detail.

A feature of a semiconductor integrated circuit of the present invention is that a semiconductor chip (LSI chip) is divided into a plurality of areas; and clocks are distributed to the corresponding one of the areas and whose phases are differentiated from each other.

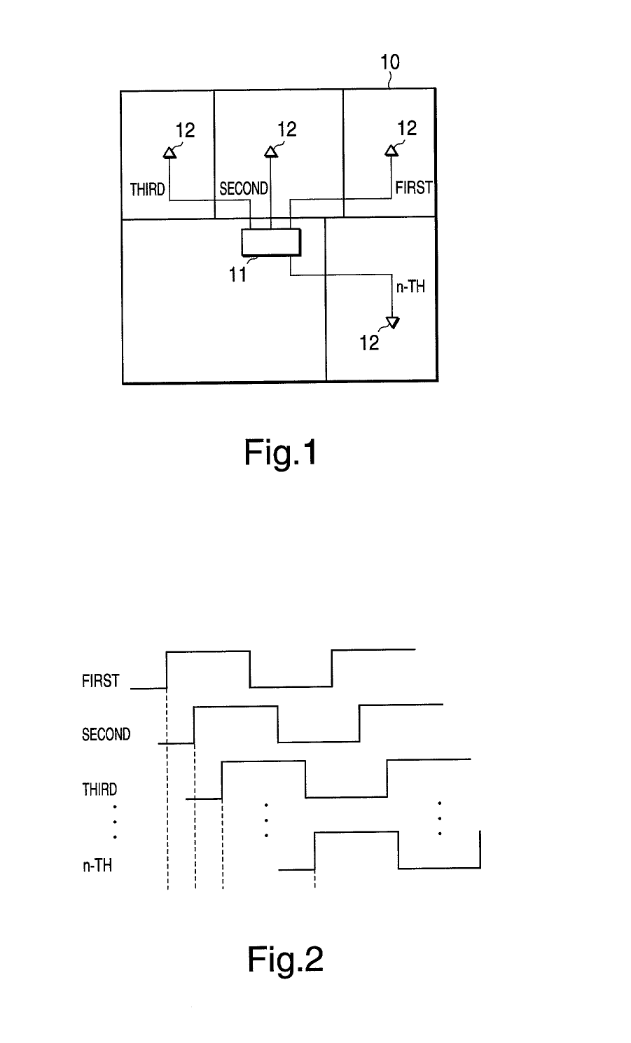

Referring to FIG. 1, in an example of semiconductor integrated circuit according to the first embodiment of the present invention, a semiconductor chip 10 is divided into a plurality of areas, i.e., n areas from the first to n-th. The clock distributed to each of the first to n-th areas of the semiconductor integrated circuit is shown in FIG. 2.

In the semiconductor integrated circuit of this embodiment, as shown in the example of FIGS. 1 and 2, the semiconductor chip 10 is divided into a plurality of areas. Semiconductor chip 10 has a phase separation element 11 which differentiates the phases of said clocks from the others and distributes said clocks to said areas, respectively. As shown in FIG. 2, phase separation element 11 shifts the phase of each of the clocks by the predetermined phase corresponding to each of the areas.

The phase separation element 11 distributes a clock to a clock driver 12 of each area. In the timing chart of FIG. 2, a state is shown in which the phase of the clock distributed to each area by the phase separation element 11 is shifted one from another. The phase separation element 11 has an element which sets and distributes the phase of each of clocks so that start points of each cycle of the clocks to be distributed to the areas, respectively, are at different timings with each other for each of the areas.

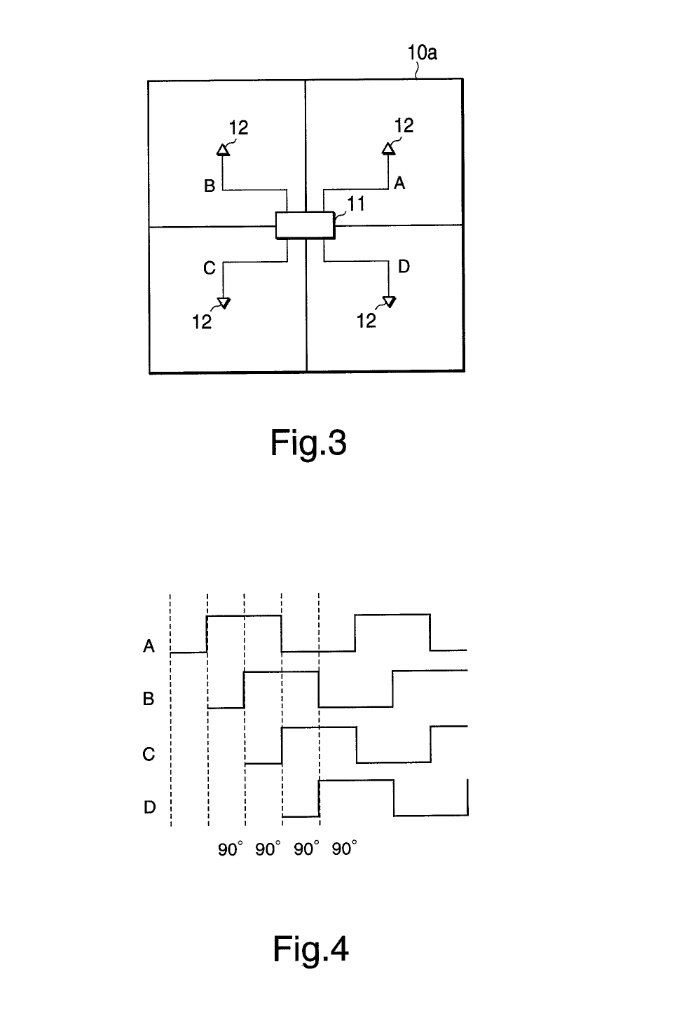

Referring to FIG. 3, in an example of construction of the semiconductor integrated circuit according to the first embodiment of the present invention, a semiconductor chip 10a is divided into four areas bounded by the chip center.

In particular, in the example of FIG. 3, using the square semiconductor chip 10a, it is divided equally into four areas. In the below description, assuming a two-dimensional coordinate system setting the chip center as the origin, these four areas will be referred to as the first to fourth quadrants.

The clock distribution of each quadrant is closed within the quadrant and independent of the clock distribution of another quadrant. Here, the clock distribution in the area of each quadrant is not shown and represented by the clock driver 12. In FIG. 3, clocks of A, B, C, and D are distributed to the areas of the first to fourth quadrants, respectively.

The phase separation element 11 distributes A to D clocks to the respective areas of the semiconductor chip 10a of FIG. 3. Referring to FIG. 4, the phase separation element 11 distributes the A to D clocks whose phases are each 90° shifted, to the respective areas of the first to fourth quadrants.

Besides, wirings between the phase separation element 11 and the clock driver 12 are formed to have the same delay by, e.g., a method of the same length/same load.

Next, the operation of the embodiment will be described.

The operation of clock distribution of the semiconductor integrated circuit of this embodiment of FIG. 3 will be described. To the areas of the respective quadrants of FIG. 3, as shown in FIG. 4, the A to D clock signals whose phases are each 90° shifted are distributed by the phase separation element 11.

Although not shown here, in each quadrant, clock distribution can be performed on the basis of the clock distribution method of a conventional semiconductor integrated circuit. That is, for example, in each quadrant, the circuit can be operated by a synchronous clock.

The delay from the clock driver 12 to the distribution terminal end element (flip flop or the like) is designed to be equal in all quadrants. A reason of this design is to perform distribution to the distribution terminal end element without destroying the relation in clock phase among the areas, taken out by the phase separation element 11.

Although clock transfer is required for exchanging data between neighboring quadrants, by designing as above, not asynchronous design but synchronous design can be made. For example, viewing the first quadrant as the center, upon data exchange from the first quadrant to the second quadrant or from the fourth quadrant to the first quadrant, a synchronous design is made in which clock transfer of “0.25T” or “1.25T” is performed. Here, the letter “T” represents one cycle of clock.

Since the design restriction is severe due to clock skew and so on in the transfer of “0.25T”, substantially the “1.25T” transfer is a practical choice. The transfer in the reverse direction is a synchronous design of “0.75T”.

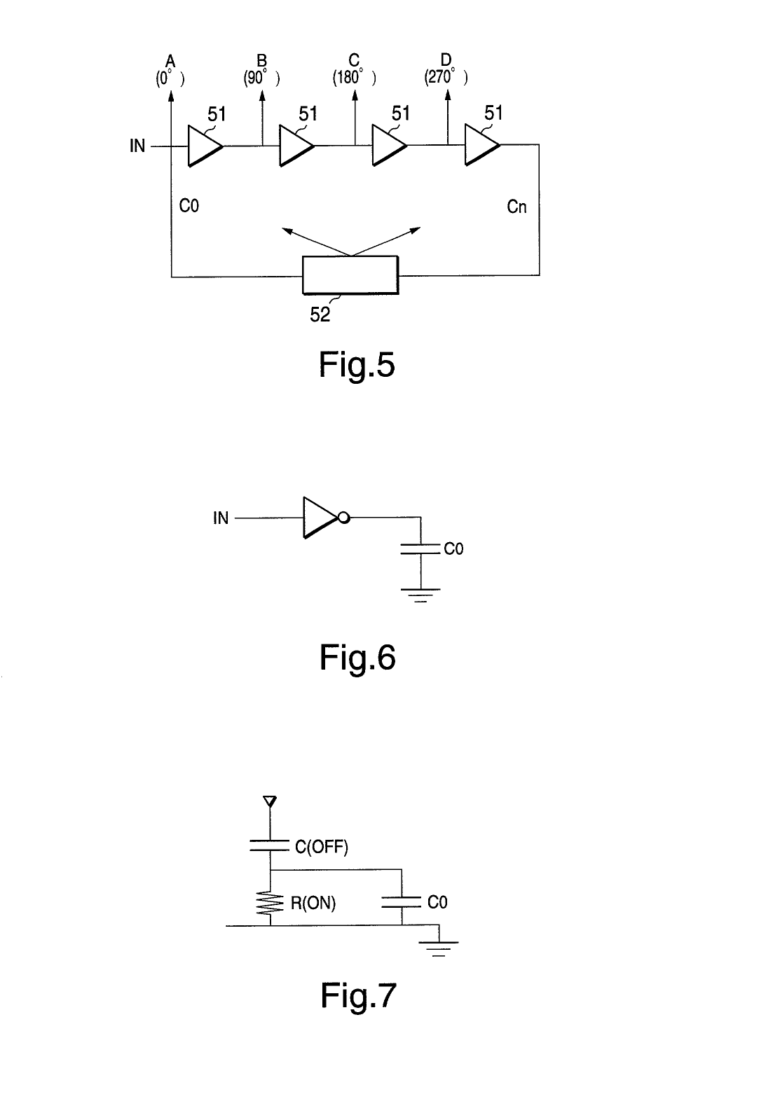

Referring to FIG. 5, in the phase separation element 11 of this embodiment, four delay gate circuits 51 are connected in series, and comparing in a phase comparator 52 so that signal Cn is delayed from signal CO just by “1T”, the delay amount of each delay gate is controlled. By controlling each delay gate so that signal Cn is shifted from signal CO by “1T”, and taking out signals between the delay gates, signals whose phases are each 90° shifted can be taken out as 0°, 90°, 180°, and 270°. Here, it is a well-known technique to realize the above-described delay by constructing the phase separation element 11 as shown in FIG. 5 using the delay gates 51, the phase comparator 52, and so on.

As described above, in the semiconductor integrated circuit of this embodiment, since it is operated with the clocks of the quadrants each 90° shifted thus, there are the following effects.

First, as an important feature, the semiconductor chip is divided into a plurality of areas and clock distribution can be performed in each area. If the distribution range becomes small, it becomes easy to decrease clock skew due to clock distribution. Further, the number of clock driver stages can be reduced and the wiring between clock drivers can be shortened. Besides, the smaller the range is, the less the unevenness in manufacture of transistor elements is. Therefore, clock skew can be reduced and the number of design steps of clock distribution can be reduced.

Second, by designing the clock distribution delay of the quadrants to be equal, the data transfer between the quadrants can be designed as not asynchronous design but synchronous design, and a surplus asynchronous circuit that deteriorates latency for clock transfer need not be added, so the circuit scale may not be increased.

Third, a critical path including, e.g., memory macro or large hard macro, in which transfer by “1T” within one cycle of clock is severe can be constructed across the quadrants and designed to be a transfer more than “1T” by clock transfer. In the above embodiment, by constructing these at a portion where clock transfer is performed by “1.25T”, clock transfer in which latency becomes bad naturally can effectively be utilized and the delay design of a memory or large hard macro can be made remarkably easily in comparison with a conventional one.

Fourth, as still another important feature, the number of clock-driven circuits (that means circuits operate with clock) operating at once can be dispersed over time. By this, a peak current of LSI decreases. That is, although the mean consumption current in one cycle of clock (1T) does not differ from that of an LSI of clock distribution by the conventional method, since the peak current decreases, power supply noise due to a power supply voltage drop or caused by a current decreases, and the stabilization of circuit operation can be intended. Further, by the decrease in peak current, a latch-up phenomenon becomes hard to occur and it contributes an improvement of reliability. Besides, since the circuits operating at once are dispersed over time, there is also an effect that a transistor not operating works as a capacitor between power supply and ground and contributes a decrease in noise.

This will be described with reference to FIGS. 6 and 7. FIG. 6 is a diagram showing an inverter circuit as a clock driver, and FIG. 7 is a diagram showing an equivalent circuit of FIG. 6. In many cases, such a clock driver circuit is an inverter, so the description is made using the inverter circuit. Reference “Co” represents the load capacity of the inverter.

When the input signal “IN” of FIG. 6 is at high level, as shown in FIG. 7, it can be equivalently shown with a resistance R because an N-type transistor is turned on, and a capacitor C because a P-type transistor is turned off. When the input signal “IN” is at low level, only the relation of on/off described here becomes reverse and there is no substantial difference, so the description is omitted. Therefore, the inverter circuit in which the input signal does not operate works as a pseudo-capacitor between power supply and ground.

In the semiconductor integrated circuit of the present invention, because of a method of distributing with intentionally shifting the clock phase, there are many clock drivers each operating as a capacitor when another clock operate. In the example of FIG. 3, substantially half of the clock drivers of the chip can work as such a pseudo-capacitor with each other. By this, there is an effect of contributing a decrease in noise.

Incidentally, the effects of the semiconductor integrated circuit of this embodiment as described above are not limited to the case of the embodiment of FIG. 3 in which the semiconductor chip 10a is divided into four areas. Even in case that the semiconductor chip 10 is divided into another arbitrary plurality of areas, the above effects can be realized in the same manner.

Next, the second embodiment of the present invention will be described in detail. A semiconductor integrated circuit of the second embodiment of the present invention is provided with two different kinds of clock frequencies.

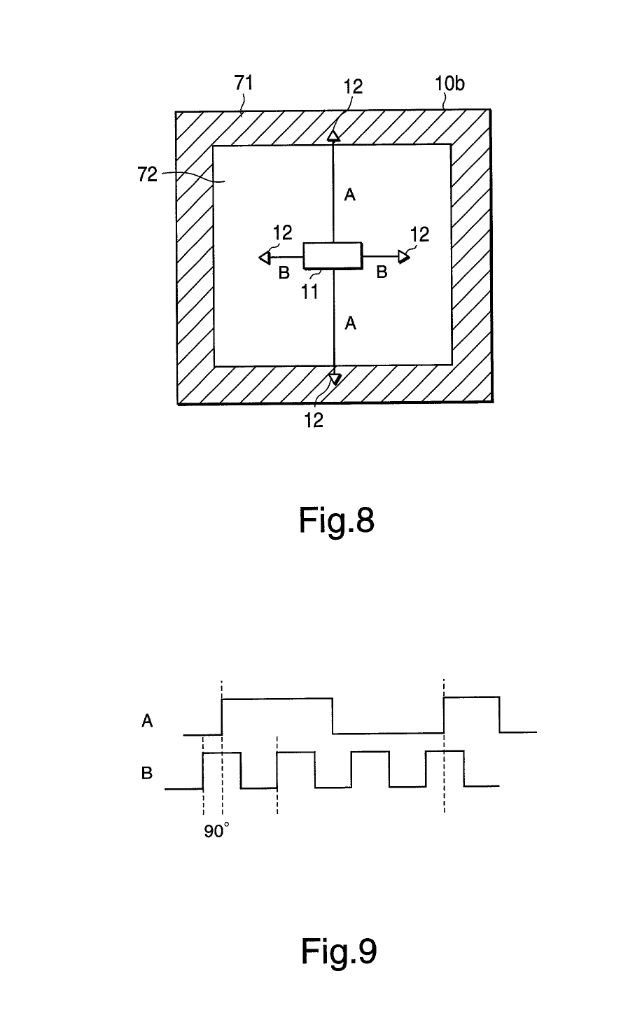

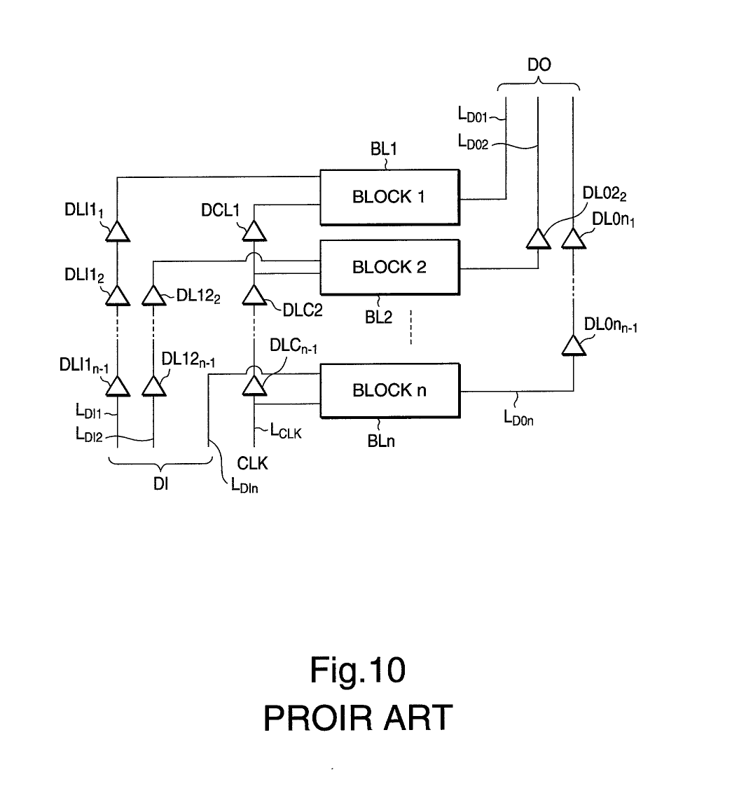

Referring to FIG. 8, the semiconductor integrated circuit of this embodiment includes, in a semiconductor chip 10b, two areas, i.e., an input/output buffer section (hereinafter, referred to as IO section) 71 and a logic section 72 (hereinafter, referred to as core section) in the LSI. The circuit is designed so that the IO section 71 and the core section 72 differ in clock frequency from each other.

Here, the description is made using an example in which the clock B of the core section 72 is operated by the clock frequency triple the clock A of the IO section 71.

In this case, as shown in FIG. 9, distribution can be made so that a clock edge of the IO section 71 is shifted by “π/2” of the clock frequency of the core section 72. More specifically, phase separation element 11 sets a length of a cycle of the clock B to be a predetermined integral times of a cycle of the clock A, and makes a start point of the cycle of the clock B concur with a start point of the cycle of the clock A shifted by “π/2” of the cycle of the clock A; and distributes the first and second clocks to the IO section 71 and the core section 72, respectively. By this, the effects described in the prior first embodiment can be obtained in the same manner.

Here, in case that the shift in phase is “180°” (in case that a rise edge of the clock A of the IO section and a fall edge of the clock B of the core section synchronize), after all, since the number of circuits operating at once does not decrease, the noise decrease effect is reduced. However, by designing so that the edges do not overlap, the effects by clock distribution of the present invention can fully be drawn out.

As described above, according to the semiconductor integrated circuit and the clock distribution method thereof of the present invention, a large number of steps are not required for clock distribution design, and even in case of a large dye size, a decrease in clock skew of the LSI can be realized, and simultaneously a peak current of the LSI due to the clock distribution circuit can be held down, and it is possible that the latency of a path through memory macro is not deteriorated more than the necessity.

While this invention has been described in conjunction with the preferred embodiments described above, it will now be possible for those skilled in the art to put this invention into practice in various other manners.

What is claimed is:

1. A semiconductor integrated circuit comprising:
a plurality of areas which operate with independent clocks, respectively; and
a phase separation element which differentiates the phase of one of said clocks from the phases of the other clocks and distributes said clocks to said areas, respectively.

2. The semiconductor integrated circuit as claimed in claim 1, wherein said phase separation element shifts the phase of each of said clocks by the predetermined phase corresponding to each of said areas.

3. The semiconductor integrated circuit as claimed in claim 1, wherein said clocks have the same cycle; and
wherein said phase separation element differentiates said phases of said clocks by shifting said phases of said clocks by a period produced by dividing said cycle equally into a number corresponding to the number of areas and distributes said clocks to said areas, respectively.

4. The semiconductor integrated circuit as claimed in claim 1, wherein said areas include four areas;
wherein said clocks include four clocks but has the same cycle; and
wherein said phase separation element differentiates said phases of said four clocks by sifting their phases by “0”, “π/2”, “π”, and “3π/2”, respectively, and distributes said four clocks to said four areas, respectively.

5. The semiconductor integrated circuit as claimed in claim 1, wherein said areas include two areas;
wherein said clocks include two clocks but has the same cycle; and
wherein said phase separation element differentiates said phases of said two clocks by shifting the phases by “π/2” with each other, and distributes said two clocks to said two areas, respectively.

6. The semiconductor integrated circuit as claimed in claim 1, wherein said areas include two areas;
wherein said clocks include a first and a second clocks; and
wherein said phase separation element sets a length of a cycle of said second clock to be a predetermined integral times of a cycle of said first clock, makes a start point of said cycle of said second clock concur with a start point of said cycle of said first clock shifted by “π/2” of said cycle of said first clock, and distributes said first and second clocks to said two areas, respectively.

7. The semiconductor integrated circuit as claimed in claim 1,
wherein said phase separation element comprises an element which sets and distributes the phase of each of said clocks so that start points of each cycle of said clocks to be distributed to said areas, respectively, are at different timings with each other for each of said areas.

8. A clock distribution method of a semiconductor integrated circuit, comprising:
differentiating the phase of one of clocks from the phases of the other clocks; and
distributing said clocks to areas, respectively, provided in a semiconductor chip and operating with independent clocks.

9. The clock distribution method as claimed in claim 8, wherein said phases of clocks are differentiated by shifting the phase of said clock by the predetermined phase corresponding to each of said areas during said differentiating step.

10. The clock distribution method as claimed in claim 8, wherein said clocks has the same cycle, and
wherein said phases of said clocks are differentiated by shifting the phases of said clocks by a period produced by dividing said cycle equally into a number corresponding to the number of areas during said differentiating step.

11. The clock distribution method as claimed in claim 8, wherein said areas includes four areas;
wherein said clocks includes four clocks but has the same cycle;
wherein said phases of said four clocks are differentiated by sifting their phases by “0”, “π/2”, “π”, and “3π/2”, respectively, during said differentiating step; and
wherein said four clocks are distributed to said four areas, respectively, during said distributing step.

12. The clock distribution method as claimed in claim 8, wherein said areas consists of two areas;
wherein said clocks includes two clocks but has the same cycle;
wherein said phases of said two clocks are differentiated by shifting the phases by “π/2” with each other during said differentiating step; and
wherein said two clocks are distributed to said two areas, respectively, during said distributing step.

13. The clock distribution method as claimed in claim 8, wherein said areas include two areas;
wherein said clocks include a first and a second clocks;
wherein a length of a cycle of said second clock is set to be a predetermined integral times of a cycle of said first clock, and a start point of said cycle of said second clock is made concur with a start point of said cycle of said first clock shifted by “π/2” of said cycle of said first clock during said differentiating step; and
wherein said two clocks are distributed to said two areas, respectively, during said distributing step.

14. A manufacturing method of a semiconductor integrated circuit, comprising:
forming a plurality of areas that operate with independent clocks to a semiconductor chip; and
forming a phase separation element which distributes said clocks to said plurality of areas, respectively, with shifting phases by a length corresponding to a phase set for each of said areas.
